(19) United States
(12) Patent Application Publication
(10) Pub. No.: US 2022/0304351 A1
(43) Pub. Date: Sep. 29, 2022

(54) EMULSIFIED CONDIMENT

(71) Applicant: McCormick & Company, Inc., Hunt Valley, MD (US)

(72) Inventors: Breanne J MCDAVID, Lutherville Timonium, MD (US); Ronald MOORE, JR., Stewartstown, PA (US); Dennis David ROBERTSON, Westminster, MD (US)

(73) Assignee: McCormick & Company, Inc., Hunt Valley, MD (US)

(21) Appl. No.: 17/212,305

(22) Filed: Mar. 25, 2021

(51) Int. Cl. A23L 27/00; A23L 27/18; A23L 23/00; A23L 27/40

(52) U.S. Cl. CPC A23L 27/80; A23L 27/18; A23L 23/00; A23L 27/40; A23V 2002/00

(57) ABSTRACT

An emulsified condiment including ground, cracked, or milled mustard seeds, an acid component such as vinegar, water, and a significant amount by weight of an edible oil, provides a condiment with a thick, spreadable texture, a creamy mouthfeel, and separation stability without the inclusion of emulsion forming gums or additives. The process of making the condiment includes rough cracking mustard seeds, mixing the mustard seeds with water, an oil, an acid component, and water to obtain a mixture, soaking the mixture with moderate agitation, stone milling the mixture, and deaerating the mixture.

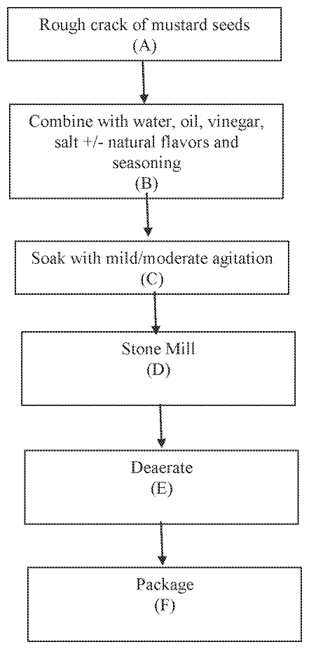

### TECHNICAL FIELD

The field of art to which this invention generally pertains is em technology, and specifically edible emulsions.

### BACKGROUND OF THE INVENTION

Traditional mustards exhibit phase separation, and over time, water separates and rises to the top of the mustard. Other condiments that do not exhibit separation are typically made using a colloid mill, along with additives such as starches and gums to keep the product homogenous. However, the conventional additives used to control this separation are less desirable to today's health-conscious consumers, who are looking for products made with more natural ingredients and/or more simplified ingredient statements.

The embodiments described herein address these challenges.

### SUMMARY OF THE IN VENTION

An emulsified condiment having a thick, spreadable texture, a creamy mouthfeel, and separation stability contains ground, cracked, or milled mustard seeds, an acid component, water, and 5% to 45% by weight, preferably from about 10% by weight to about 25% by weight of an oil, based upon the weight of the emulsified condiment. Mucilage of the mustard seeds provides emulsification of the water and the oil without the inclusion of emulsion forming gums or emulsion forming additives or colloid mill processing. In embodiments of the invention, the ground, cracked or milled mustard seeds may be present in an amount of about 7% by weight to about 18% by weight, preferably about 8% by weight to about 15% by weight, more preferably from about 10% by weight to about 14% by weight, the acid component may be present in an amount sufficient to deliver acid or acid equivalent in an amount of about 0.7% by weight to about 3% by weight, preferably about 1.0% by weight to about 2.2% by weight, and the total water content of the emulsified condiment may be about 25% by weight: to about 75% by weight, preferably about 30% by weight to about 50% by weight, said weight percentages being based upon the weight of the emulsified condiment.

In preferred embodiments, the acid component comprises vinegar. The amount of vinegar may be from about 8% by weight to about 25% by weight, based upon the weight of the emulsified condiment, and the acetic acid content of the vinegar may be about 5% by weight to about 20% by weight, based upon the weight of the vinegar.

In embodiments of the invention, the emulsified condiment may further include at least one spice, seasoning, oleoresin, flavoring agent: or flavor, alcohol component or alcoholic beverage, and mixtures thereof, such as salt, natural flavoring, spice and/or seasoning, in an amount up to about 30% by weight, based upon the weight of the emulsified condiment. The emulsified condiment may be a :mustard, or a sandwich spread, or a dipping sauce.

in embodiments of the invention, the emulsified condiment may have a viscosity greater than 25,000 cP as measured on a Brookfield Viscometer using spindle 6 at 10 RPMs for 90 seconds at 20-22° C.

The process of making the emulsified condiment may include rough cracking mustard seeds, mixing the mustard seeds with the water, oil, acid component, and water to obtain a mixture, soaking the mixture with moderate agitation, stone milling the mixture, and deaerating the mixture, resulting in an emulsified condiment with a thick, spreadable texture, a creamy mouthfeel, and separation stability, wherein mucilage of the mustard seeds provides emulsification of the water and the oil without the inclusion of emulsion forming gums or emulsion forming additives or colloid mill processing.

In embodiments of the invention the at least one spice, seasoning, oleoresin, flavoring agent or flavor, alcohol component or alcoholic beverage, and mixtures thereof in an amount up to about 30% by weight, based upon the weight of the emulsified condiment may be admixed with the mustard seeds, water, oil, acid component, and water to obtain a mixture which may be soaked with moderate agitation, stone milled, and deaerated to obtain the emulsified condiment.

The stone milling may be conducted to obtain an emulsified condiment, such as a mustard or sandwich spread, having a viscosity greater than 25,000 cP as measured on a Brookfield Viscometer using spindle 6 at 10 RPMs for 90 seconds at 20-22° C., and to obtain an average particle size range of the stone milled mustard seeds in the finished condiment in the range of 5 microns to 1,000 microns, for example 25 microns to 65 microns.

These and additional embodiments are further described below.

### BRIEF DESCRIPTION OF THE DRAWINGS

The Sole FIGURE depicts a representative process as described herein.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should. not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention, As used in the description of the invention and the appended claims, the singular forms “a,” “an” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

The process described herein produces an emulsified condiment made using oil, mustard seed, acid, and water. In embodiments of the invention, the moisture content, oil content, and mustard seed content, of the emulsified condiment of the present invention should be sufficient to provide the desired consistency for a smooth, creamy texture, spreadability on a substrate, such as bread, without excessive soaking of the substrate, and maintaining a stable emulsion. Also, the moisture, oil, and mustard seed contents should be sufficient to enable proper machining, and flow from product packaging, such as squeeze bottles with narrow openings. In embodiments of the invention, the acid content of the emulsified condiment should be sufficient to provide microbial stability to the emulsified condiment, which does not need heat treatment to establish microbial stability, and a prolonged spiciness and pungency, but not so high an amount that would adversely affect a mild sensory perception. Also, in embodiments of the invention, the mustard seed content should be sufficient to provide a spicy, pungent taste, and a sufficient amount of mucilage to emulsify the oil and the water or moisture content into a stable emulsion over a prolonged period of time without the addition of other emulsifiers.

In embodiments of the invention, the total moisture content of the emulsified condiment of the present invention will include any water included as a separately added ingredient, as well as the moisture provided by acid components such as vinegar (which usually contains about 80% to about 95% by weight water and about 5% by weight to about 20% by weight acetic acid, based upon the weight of the vinegar), and the moisture content of other additives included in the formulation, such as honey, high fructose corn syrup, invert syrups, alcoholic components or alcoholic beverages, or other liquid humectants or flavorings.

Taking into account all sources of water or moisture, the emulsified condiment, including separately added water, and for example vinegar, the total water or moisture content of the emulsified condiments of the present invention may he from about 25% by weight to about 75% by weight, preferably from about 30% by weight to about 50% by weight, for example, from about 35% by weight to about 45% by weight, based upon the weight of the emulsified condiment.

In embodiments of the invention, the acid component may he present in amounts sufficient to deliver about 0.7% by weight to about 3% by weight, preferably about 1.0% by weight to about 2.2% by weight acid, such as acetic acid or equivalent acid, the weight percentages being based upon the total weight of the emulsified condiment. Acetic acid is the preferred acid, but other edible organic or inorganic acids, mixtures thereof and salts thereof may be employed. Organic acids are preferred. Exemplary organic acids which may he used include citric acid, tartaric acid, succinic acid, fumaric acid, lactic acid, ascorbic acid, linoleic acid, palmitic acid, oleic acid butyric acid, and malic acid, and mixtures thereof and salts thereof. Exemplary inorganic acids which may be employed include food grade phosphoric acid, hydrochloric acid, mixtures thereof, and one or more salts thereof. The acids have standard rates by which they may be converted to yield an “equivalent” acidic value. For example, the equivalent weight of an acid or base for neutralization reactions or of any other compound that acts by double decomposition is the quantity of the compound that will furnish or react with or be equivalent to 1.00797 g of hydrogen ion or 17.0074 g of hydroxide ion. It is the weight of a compound that contains one equivalent of a proton (for acid) or one equivalent of a hydroxide (for base),

The acid component may be employed in solid or particulate form or liquid form. In embodiments of the invention, a solid acid component may be dissolved in water to form an aqueous solution with the added water component. In other embodiments, the acid component may include an aqueous source of acid such as lemon juice and/or vinegar. Natural aqueous sources of acids are generally preferred. The preferred acid component is vinegar which may be employed as a source of acetic acid. The vinegar is also a source of the water component along with any added water.

In embodiments of the invention, the amount of vinegar employed depends upon the strength. For example, for vinegar of 120 grain strength, or 12% by weight acetic acid, based upon the weight of the vinegar, the amount of vinegar may range from about 8% by weight to about 25% by weight, for example from about 10% by weight to about 20% by weight, based upon the weight of the emulsified condiment, such as prepared mustard. Examples of vinegars which may be employed as the acid component include one or more cooking vinegars, such as white vinegar, white wine vinegar, white distilled vinegar, balsamic vinegar, rice vinegar, champagne vinegar, red wine vinegar, apple cider vinegar, sherry vinegar, malt vinegar, and mixtures thereof.

In preferred embodiments, the emulsified condiment of the present invention is manufactured and packaged at ambient temperatures, and therefore does not have a heat treatment or “kill” step to eliminate microbial contamination. Therefore, it must be formulated with enough acid to inhibit microbial growth and provide a microbiological safety hurdle. Cold processed and cold filled products, such as the emulsified condiments of the present invention should not support the growth of spoilage microorganisms if the following parameters are met: 1) is less than or equal to 4.1, and 2) titratable acidity expressed as acetic acid in the aqueous phase is equal to or greater than 2.0%. This percentage can be calculated via the following equation:

[(% lower titratable acidity as acetic acid specification)/(% upper moisture specification)]×100.

However, to formulate a product with an acceptable flavor, the vinegar level must be low enough that it is not considered too sour, as determined by hedonic testing with consumers of the product. The optimum balance between food safety and consumer preference is found when the acetic acid to moisture content ratio is slightly greater than, or equal to, 2.0% as calculated using the formula above.

The mustard seed component provides multiple purposes in the emulsified condiment or mustard formulation. It stabilizes the emulsion, builds viscosity, and provides flavor. The naturally present emulsifier, mucilage comes from the outer coating of the mustard seed. in embodiments of the invention, the mustard seed is employed in amounts which provide mucilage in an amount which stabilizes the emulsion of the water component and the added oil component, without the need for the inclusion of additional emulsifiers, such as emulsion forming gums, starches, or other additives, and without the need for colloid mill processing. If too much seed is added, the viscosity will he too thick to run through the stone mill. Even if the product is able to pass through the stone mill, the upper seed amount is further limited depending on packaging type. For example, if packaged in a squeezable plastic bottle with a small opening in the closure, the viscosity needs to he lowered to a level where it is able to be evacuated from the bottle with ease. However, if too little an amount of mustard seed is added, the resulting product will he too thin and there will not be enough mucilage to properly stabilize the emulsion, allowing the added oil and water phases to separate. The amount of mustard seed required to stabilize the emulsion has a direct relationship with the amount of oil in the emulsified condiment formula. A lower added oil amount or content will require less mucilage and therefore less mustard seed to form a stable emulsion. A higher added oil amount or content will require more mucilage and therefore more mustard seed to form a stable emulsion.

The mustard seed component may be present in amounts of about 7% by weight to about 18% by weight, preferably from about 8% by weight to about 15% by weight, more preferably from about 10% by weight to about 14% by weight, based upon the weight of the emulsified condiment, such as yellow mustard. The mustard seed may be any edible mustard seed of a mustard plant such as white/yellow mustard, Sinapis alba, brown mustard, Brassica junceo, black mustard, Brassica nigra, and mixtures thereof. Yellow mustard seeds are preferred. The whole grain mustard seeds are usually about 1 to 2 millimeters (0.039 to 0.079 in) in diameter and may he colored from yellowish white to black. However, in embodiments of the present invention the whole grain mustard seeds are ground, cracked or milled, preferably rough cracked, for example in a conventional seed mill, such as a micromill, prior to incorporation into the emulsified condiment. Prior to incorporation into the emulsified condiment, the ground, cracked, or milled mustard seeds may have a particle size of from about 500 microns to about 2,000 microns, prior to wet stone milling in accordance with the process of the present invention. In embodiments of the invention, the average particle size of the cracked mustard seed before milling may be about 1,300 microns prior to wet stone milling.

In embodiments of the present invention, the average particle size range of the mustard seeds is reduced by stone milling to obtain an average particle size in the finished emulsified condiment after stone milling (by appropriately setting the gap on the mill) to 5-1,000 microns, preferably 25-65 microns. The particle size is determined using a micrometer.

The oil component is added in an amount to provide a creamy smooth texture or mouthfeel in the emulsified condiment. in embodiments of the invention, the resulting product has a unique, thick texture and creamy mouthfeel. Use of the oil component also helps to reduce the amount of added water, to lower the water activity of the emulsified condiment which helps to improve microbial shelf stability. Accordingly, the amount of the acid component, such as vinegar, may be reduced to provide more mild flavors while retaining microbial shelf stability. Also, traditional condiments like mustard are very watery and thin, and can soak into the bread of a sandwich, making it soggy. With the thicker, more spreadable texture of the mustard emulsions of the present invention, there is less syneresis (water separation) and free water available to soak into the bread. In addition, the presence of oil acts as a water barrier, helping to prevent the water from soaking into the bread, which makes the emulsified condiments of the present invention particularly unique from conventional mustard compositions which do not contain an added oil component.

In embodiments of the invention, the added oil component may be present in an amount of about 5% by weight to about 45% by weight, preferably from about 10% by weight to about 25% by weight, for example from about 15% by weight to about 22% by weight, based upon the weight of the emulsified condiment. The amount of oil employed should be controlled so as not to observe oil separation. In embodiments of the invention, the emulsion may be an oil-in-water emulsion, with very small droplet sizes produced by the stone milling.

Any food grade oil, including any vegetable oil or seed oil, such as soybean oil, peanut oil, sunflower oil, olive oil, avocado oil, corn oil, canola oil, rape seed oil, palm oil, palm kernel oil, safflower oil, and mixtures thereof can be used as the oil component in embodiments of the present invention.

Additional optional components can include flavoring agents such as salts (NaCl or KCl, for example), conventional natural flavors and seasonings, such as herbs and spices, turmeric for coloring, oleoresins, alcohol components or alcoholic beverages, etc. to produce Dijon, yellow, spicy brown, honey mustard, and other traditional mustard flavors. Exemplary amounts of the optional oleoresins, conventional flavors and seasonings or spices for traditional mustard flavors may generally range up to about 1% by weight, for example from about 0.005% by weight to about 10% by weight.

In other embodiments, the emulsified condiments of the present invention may be sandwich spreads or dipping sauces that are not traditional mustard flavors. For example, emulsified condiments with flavors such as honey chipotle, hickory jalapeno, brown sugar bourbon, roasted garlic, etc. can. be produced in accordance with embodiments of the present invention. The honey chipotle flavor may include spices, honey, and natural flavor. A sweet Applewood formulation may contain apple juice concentrate, sugar, and molasses, for example. in other embodiments of the invention, the additional optional components may be an alcoholic component or alcoholic beverage, such as bourbon, whiskey, tequila, any type of red wine, any type of white wine, any type of beer, etc. In embodiments of the invention, the additional optional components may be employed in amounts up to about 30% by weight, based upon the weight of the emulsified condiment.

The average particle size range in the finished condiment after stone milling (by appropriately setting the gap on the mill) is typically 25-65 microns, with the entire range being 5-1,000 microns. The particle size is determined using a micrometer.

The creamy mouthfeel produced by the composition described herein refers to its creamy and smooth texture. This also relates to its viscosity and rheology, which can be observed on a mustard slick board, and is measured with reference to a standard established for the composition by observation. Once the desired, observed standard is established, particular compositions can be modified to meet the established standard by increasing or decreasing seed volume to impact viscosity. The texture and fineness of particles can also he adjusted to impact composition viscosity and smoothness. The gap sizes of the mill may be adjusted to control texture, fineness of the particles, composition viscosity, and smoothness of the composition. Conventional mustards typically fall within the 5,000 to 20,000 centipoise (cP) range (as measured on a Brookfield Viscometer, such as the DV-I Prime model, using spindle 4 at 10 RPMs for 90 seconds at 20-22° C. The viscosity of the mustard as described herein, is typically in excess of 25,000 cP, preferably at least 30,000 cP, for example 35,000 cP or more, generally up to about 65,000 cP, as measured on a Brookfield Viscometer using spindle 6 at 10 RPMs for 90 seconds at 20-22° C.

Prepared mustard has existed for over 100 years, and the use of mustard as a condiment has been around for centuries. Prepared yellow mustard as we know it today was introduced to the public, and subsequently available for commercial sale, after debuting at the 1904 St. Louis World's Fair by the R.T. French Company. The mustard compositions described herein bring true innovation to this category.

In embodiments of the present invention, the spreadable, emulsified condiments, such as emulsified mustards, may be produced by rough cracking or grinding mustard seeds, mixing cracked or ground mustard seeds with water, food grade oil, the acid component, such as vinegar, and water, soaking the mixture with moderate agitation, stone milling the mixture, and deaerating the mixture, to obtain a stabilized emulsified condiment having a thick, spreadable texture, a creamy mouthfeel, and separation stability without the inclusion of emulsion forming gums or additives or colloid mill processing. Soaking of the cracked or ground mustard seeds in the water oil and acid mixture prior to stone milling helps to release the mucilage from the seeds for emulsification of the oil and water during stone milling. The stone milling further reduces the particle size of the cracked or ground mustard seeks and also reduces the size of the oil droplets to provide a stable emulsion. The soaking may he at room temperature for about 5 minutes to about 30 minutes for example from about 10 minutes to about 20 minutes.

Using this process and the mucilage present in mustard seed as the natural emulsifier, there is no need for typically used additives/gums, such as modified starches, to stabilize the emulsion, and no need for the use of a conventional colloid mill which is traditionally required to create emulsions, especially for condiments. Traditional mustards are not emulsions the present compositions are shelf-stable emulsions.

The addition of 5% to 45% by weight of the oils in embodiments described herein, even to conventional mustard formulations, and even with processing similar to traditional condiment processing (typical mustard processing excluded), yields an entirely different condiment with respect to texture. Even if all the same ingredients were used but they were run through traditional processing equipment associated with making emulsified condiments, it would not yield the same result. The stones of the mustard mill serve two purposes by crushing the mustard seeds and providing the high shear needed to reduce oil droplet size and create an emulsion. Although other emulsifying equipment provides high shear and reduces particle size, they are not designed to grind down mustard seeds like a stone mill grinds the mustard seeds.

The emulsions created in embodiments of the present invention are stable, i.e the emulsions do not show any significant oil layer separation when subjected to shaking in a conventional orbital shaker, even at 45° C. for 5 days. Also noteworthy is that emulsion stability is achieved entirely without the use of traditional emulsifying food additives, like xanthan gum or starches. The water and oil are held together by the natural emulsification properties of the mucilage in the mustard seed,

The process of using a stone mill to create an emulsified mustard product is unique. While stone mills have been used for mustard, they have not been used in the context of producing an emulsified product. For that purpose, high shear devices like a colloid mill have been found to produce a less viscous, less creamy product, subject to higher syneresis, or require the addition of emulsifying agents such as gums and starches,

Unexpected superior sensory attributes are also produced by this unique process as described herein. In addition to the added oil, the milder flavor observed after aging can be explained by the lower amount of vinegar required in the formula to achieve an acid moisture ratio needed for food safety reasons. However, the desired mustard pungency remains for a longer period of time compared to conventionally prepared mustard compositions. In traditional prepared yellow mustard, the spiciness and pungency tend to fade after about 14 days stored at ambient temperature (21° C.). However, the condiments of the present invention require about 6 weeks or more for pungency to fade.

Surprisingly, the incorporation of the oils as described herein, in the composition, allows for less observed phase separation (syneresis) compared to traditional yellow mustard formulations. It is believed that reduced syneresis in the finished condiment is achieved by reduced total moisture in the formula by replacement of part of the water with oil, which is bound by mucilage to the water in a stable emulsion. For example, when the emulsified condiment is spread on bread, the oil also forms a barrier between any free water and the bread to prevent sogginess, which is clearly a huge consumer benefit. There is also no need for separate emulsifying agents or gums, and no need for colloid mill processing. There is also a higher end-product: viscosity than conventional mustard. while using the same amount of mustard seed.

There are many consumer benefits to this product over existing offerings, such as:
A cleaner ingredient statement compared to other sandwich spread type condiments like mayonnaise, e.g., not needing modifiers such as food starches or gums.
Thicker and more spreadable texture than traditional mustard viscosity.
Less syneresis (free water separation) than traditional mustard compositions.
Milder flavor compared to traditional mustard.

The mustard-based condiments with added oil as described herein are not like salad dressings, as might traditionally be expected from such oil addition. The product as described herein is more like traditional mustard, but with a thicker texture, and creamier mouthfeel.

The present invention is further illustrated by the following examples, where all parts, ratios, and percentages are by weight, are pressures are atmospheric pressure, and all temperatures are in ° C., unless otherwise stated:

### EXAMPLE

Referring to the FIGURE, traditional yellow mustard seeds are rough cracked (A) in a seed mill. The rough cracked yellow mustard seeds (14% -all %'s by weight) are combined with 52% water, 20% canola oil, 10% 120 grain white vinegar, 2.5% salt, and 1.5% natural flavorings and seasonings (B), the weight percentages adding up to 100% by weight. The combined components are soaked together with mild agitation (C) for about 15 minutes. The composition is next stone milled (D) with the mill gap set at its tightest setting until the composition demonstrates a fine grind, i.e., the ability to spread smoothly on a flat surface. The composition is deaerated (E) and finally packaged (F) in conventional mustard packaging.

By way of further example, oriental and/or brown mustard seeds can be added to the mustard seed component of the composition, for different flavor and color appearance effects (up to about 50% by weight replacement, e.g., for the yellow mustard seed). The salt can be sodium chloride, potassium chloride, or any mixture of the two. Turmeric can be added to the composition, to effect color, for example, in amounts up to about 1.0% by weight based upon the weight of the emulsified condiment. Other ingredients can also be added up to about 30% by weight, based upon the weight of the emulsified condiment, to impart unique flavors to the condiment.

Moderate agitation is needed in step C to help keep the composition homogeneous when being pumped through the stone mill because the seed component could potentially sink at this point of the processing otherwise, and oil would float on top. The stone mill used can be a Jayhawk 15-50 HP stone mill, such as model numbers 3MPYB, 4MPYC, or 5MPYC manufactured by Jayhawk Manufacturing Company, Hutchinson, Kans., having outputs ranging from 70 gal/hr to 210 gal/hr. The deaeration can take place at −25 to −30 millimeters of Hg at 6 pounds per minute.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An emulsified condiment comprising:
ground, cracked or milled mustard seeds,
an acid component,
water, and
5% to 45% by weight of an oil, based upon the weight of the emulsified condiment,
resulting in an emulsified condiment with
a thick, spreadable texture,
a creamy mouthfeel, and
separation stability,
wherein mucilage of the mustard seeds provides emulsification of the water and the oil without the inclusion of emulsion forming gums or emulsion forming additives or colloid mill processing.

2. The condiment of claim 1, wherein the ground, cracked or milled mustard seeds are present in an amount of about 7% by weight to about 18% by weight, the acid component is present in an amount sufficient to deliver acid or acid equivalent in an amount of about 0.7% by weight to about 3% by weight, and the total water content of the emulsified condiment is about 25% by weight to about 75% by weight, said weight percentages being based upon the weight of the emulsified condiment.

3. The condiment of claim 1 wherein the acid component comprises vinegar.

4. The condiment of claim 2 wherein the acid component comprises vinegar.

5. The condiment of claim 3 wherein the amount of vinegar is from about 8% by weight to about 25% by weight, based upon the weight of the emulsified condiment.

6. The condiment of claim 5 wherein the acetic acid content of the vinegar is about 5% by weight to about 20% by weight, based upon the weight of the vinegar.

7. The condiment of claim 1 wherein the ground, cracked or milled mustard seeds are present in an amount of about 8% by weight to about 15% by weight, based upon the weight of the emulsified condiment.

8. The condiment of claim 7 wherein the acid component is present in an amount sufficient to deliver acid or acid equivalent in an amount of about 1.0% by weight to about 2.2% by weight:, based upon the weight of the emulsified condiment.

9. The condiment of claim 8 wherein the total water content of the emulsified condiment is about 30% by weight to about 50% by weight, based upon the weight of the emulsified condiment.

10. The condiment of claim 1, further comprising at least one spice, seasoning, oleoresin, flavoring agent or flavor, alcohol component or alcoholic beverage, or mixtures thereof in an amount up to about 30% by weight, based upon the weight of the emulsified condiment.

11. The condiment of claim 10 comprising salt, natural flavoring and/or seasoning, and wherein the ground, cracked or milled mustard seeds are present in an amount of about 10% by weight to about 14% by weight, based upon the weight of the emulsified condiment, and the amount: of the food grade oil is from about 10% by weight to about 25% by weight, based upon the weight of the emulsified condiment.

12. The condiment of claim 10 which is a mustard.

13. The condiment of claim 10 which is a sandwich spread or dipping sauce.

14. The condiment of claim 1, having a viscosity greater than 25,000 cP as measured on a Brookfield Viscometer using spindle 6 at 10 RPMs for 90 seconds at 20-22° C.

15. A process of making an emulsified condiment comprising:
rough cracking mustard seeds,
mixing the mustard seeds with water, an oil, an acid component, and water to obtain a mixture,
soaking the mixture with moderate agitation,
stone milling the mixture, and
deaerating the mixture,
resulting in an emulsified condiment with
a thick, spreadable texture,
a creamy mouthfeel, and
separation stability,
wherein mucilage of the mustard seeds provides emulsification of the water and the oil without the inclusion of emulsion forming gums or emulsion forming additives or colloid mill processing.

16. The process of claim 15, wherein the ground, cracked or milled mustard seeds are present in an amount of about 7% by weight to about 18% by weight, the acid component is present in an amount sufficient to deliver acid or acid equivalent in an amount of about 0.7% by weight to about 3% by weight, and the total water content of the emulsified condiment is about 25% by weight to about 75% by weight, said weight percentages being based upon the weight of the emulsified condiment.

17. The process of claim 15 wherein the acid component comprises vinegar.

18. The process of claim 16 wherein the acid component comprises vinegar.

19. The process of claim 17 wherein the amount of vinegar is from about 8% by weight to about 25% by weight, based upon the weight of the emulsified condiment.

20. The process of claim 19 wherein the acetic acid content of the vinegar is about 5% by weight to about 20% by weight, based upon the weight of the vinegar.

21. The process of claim 15 wherein the ground, cracked or milled mustard seeds are present in an amount of about 8% by weight to about 15% by weight, based upon the weight of the emulsified condiment.

22. The process of claim 21 wherein the acid component is present in an amount sufficient to deliver acid or acid equivalent in an amount of about 1.0% by weight to about 2.2% by weight, based upon the weight of the emulsified condiment.

23. The process of claim 22 wherein the total water content of the emulsified condiment is about 30% by weight to about 50% by weight, based upon the weight of the emulsified condiment.

24. The process of claim 15, wherein at least one spice, seasoning, oleoresin, flavoring agent or flavor, alcohol component or alcoholic beverage, or mixtures thereof in an amount up to about 30% by weight, based upon the weight of the emulsified condiment is admixed with the mustard seeds water, oil, acid component, and water to obtain a mixture.

25. The process of claim 24 wherein salt, natural flavoring and/or seasoning, are admixed with the mustard seeds, water, oil, acid component, and water to obtain a mixture, and wherein the ground, cracked or milled mustard seeds are present in an amount of about 10% by weight to about 14% by weight, based upon the weight of the emulsified condiment, and the amount of the oil is from about 10% by weight to about 25% by weight, based upon the weight of the emulsified condiment.

26. The process of claim 15 wherein the emulsified condiment is a mustard.

27. The process of claim 15 wherein the emulsified condiment is a sandwich spread or dipping sauce.

28. The process of claim 15 wherein the stone milling is conducted to obtain an emulsified condiment having a viscosity greater than 25,000 cP as measured on a Brookfield Viscometer using spindle 6 at 10 RPMs for 90 seconds at 20-22° C.

29. The process of claim 28 wherein the stone milling is conducted to obtain an average particle size range of the stone milled mustard seeds in the finished condiment in the range of 5 microns to 1,000 microns.

30. The process of claim 29 wherein the stone milling is conducted to obtain an average particle size range of the stone milled mustard seeds in the finished condiment in the range of 25 microns to 65 microns.
